(19) United States
(12) Patent Application Publication
(10) Pub. No.: US 2003/0231189 A1
(43) Pub. Date: Dec. 18, 2003

(54) Altering a display on a viewing device based upon a user controlled orientation of the viewing device

(75) Inventor: Lyndsay Williams, Girton (GB)

Correspondence Address: Richard J. Gregson, Merchant & Gould P.C., P.O. Box 2903, Minneapolis, MN, 55402-0903, US

(73) Assignee: Microsoft Corporation

(21) Appl. No.: 10/357,700

(22) Filed: Feb. 3, 2003

Related U.S. Application Data
(63) Continuation-in-part of application No. 10/159,851, filed on May 31, 2002.

(51) Int. Cl. G09G 5/00

(52) U.S. Cl. 345/659

(57) ABSTRACT

A method, apparatus, and article of manufacture altering a displayed image presented to a user on a viewing device using a user-controlled orientation of the viewing device to determine how the displayed image is to be presented. The viewing device includes a plurality of gyroscope sensors that are used to determine the orientation of the viewing device. As the user moves the orientation of the viewing device, the gyroscope sensors detect the change in the device orientation. These changes in orientation are used to alter the image being displayed upon the viewing device.

### RELATED APPLICATION

This application is a Continuation-In-Part Application that claims priority to a commonly assigned and earlier filed application titled “Altering a Display on a Viewing Device Based Upon a User Controlled Orientation of the Viewing Device, Ser. No. 10/159,851 filed May 31, 2002. This application is hereby incorporated by reference herein as if it were reproduced in its entirety herein.

### TECHNICAL FIELD

The invention relates generally to a controlling a display of an electronic image viewing device and more particularly to a system, method and article of manufacture for altering a display on a viewing device based upon a user controlled orientation of the viewing device.

### BACKGROUND

Computing systems are routinely used to display images of objects for a wide variety of purposes. Typically, these images are 2D images that present a static representation of an object. Many applications that use such images of objects find 2D static images less than desirable as they do not present a complete representation of the object to the view. For example, a buyer of watches shopping over the Internet may wish to see the watch from different perspectives to see how the face of the watch appears when reading the displayed time as well as to see how thick the watch is as it is worn on a wrist.

Image display systems have also been developed to allow a user to pan and scroll around an object to see the object from differing perspectives. Such systems typically provide a user with a flat, 2D image that provides a panoramic view of all sides of an object while allowing a user to see a portion of the image as if the user was rotating the object. Such systems are an improvement over the flat 2D image of an object; however, these images still do not provide a true perspective view of the object in a 3D concept.

When a user views items like a watch, a user would like to see the object as if it was located within a specimen box. In such a system, the user may see different perspectives of the item by “changing the orientation of the box” to obtain a different view of the object within the box. This approach will address the need to provide a 3D perspective of the item within the confines of a 2D window into the box and thus address limitations existing in earlier image presentation systems.

In the prior application, the image displayed upon a screen of a hand-held and tablet computing device is disclosed in a preferred embodiment to appear as if a displayed object is located within the computing device. As the computing device is moved, the displayed image is manipulated as if a 3-dimensional representation of the object is moved to correspond to the new orientation of the computing device. In addition, any change in the orientation of the computing device is determined in a disclosed preferred embodiment by use of a tilt sensor module providing signals to the computing system.

The invention disclosed within the prior application addresses uses of a mobile computing device in situation the image displayed is capable of displaying an entire view of an object that is to be manipulated by changing the orientation of the computing device. Other uses of a hand-held and tablet computing system to display images and other 2-dimensional representations of data in which the displayed image does not represent all of the information that may be displayed are not addressed by the prior disclosed invention. These limitations of the prior invention are addressed herein.

### SUMMARY

The present invention relates to a method, apparatus, and article of manufacture for altering a display on a viewing device based upon a user-controlled orientation of the viewing device. A system in accordance with the principles of the present invention includes a display device orientation measurement module for obtaining a measure of a spatial orientation of the display device and a mobile processing module for generating the computer generated image of an object. The computer generated image of the object is generated using the measurements of the spatial orientation of the display device to determine a displayed orientation of the object.

Another aspect of the present invention is a computer implemented method, and corresponding computer program data product, for altering a computer generated image of an object displayed upon a display device where the display device has a display device orientation measurement module for obtaining a measure of a spatial orientation of the display device. The method obtains a set of orientation measurements for the display device from the display device orientation measurement module; generates a set of x-axis and y-axis mouse commands using the set of orientation measurements for use in generating the computer generated image of an object; and applies the set of x-axis and y-axis mouse commands to a displayed image within the computer generated image.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

FIG. 1 illustrates a user of a mobile computing device to altering an image displayed upon the hand-held computing device according to one embodiment of the present invention.

FIG. 2 illustrates geometry for an object displayed onto a screen of a mobile computing device appearing to change its orientation based upon the movement of the mobile computing device according to one possible embodiment of the present invention.

FIG. 3 illustrates a mobile computing device orientation module according to another embodiment of the present invention.

FIG. 4 illustrates use of a mobile computing device orientation module that is remote from the computing device according to an example embodiment of the present invention.

FIG. 5 illustrates use of a mobile computing device appearing to display an image of a remote location according to another example embodiment of the present invention.

FIG. 6 illustrates use of another mobile computing device appearing to its physical location within a spatial coordinate system according to another example embodiment of the present invention.

FIG. 7 illustrates an exemplary mobile computing system that may be used to support various computing system that are part of example embodiments of the present invention.

FIG. 8 illustrates a block diagram for an image manipulation and display processing system according to an embodiment of the present invention.

FIG. 9 illustrates an operational flow for an image manipulation and display processing system according to yet another example embodiment of the present invention.

### DETAILED DESCRIPTION

The present invention relates to a system, method and article of manufacture for altering a display on a viewing device based upon a user controlled orientation of the viewing device.

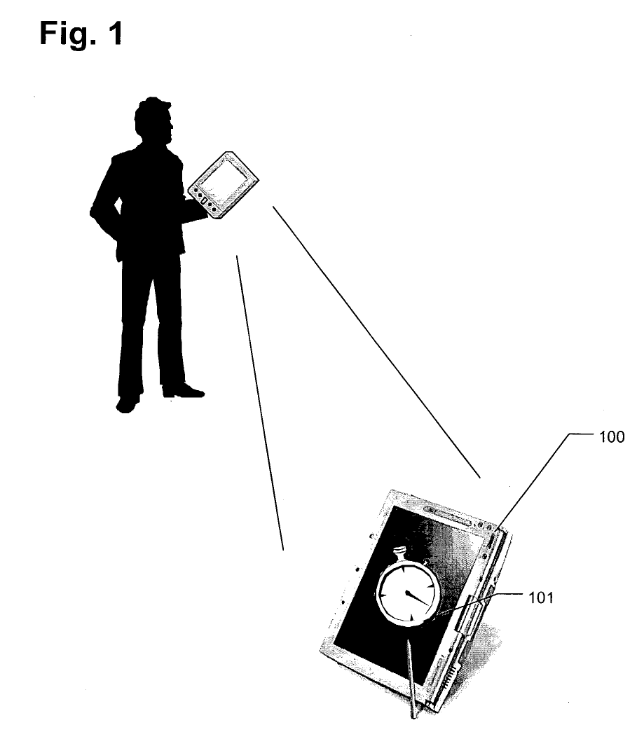

FIG. 1 illustrates a user of a mobile computing device to altering an image displayed upon the hand-held computing device according to one embodiment of the present invention. A user holds a mobile computer 100, such as a personal digital assistant (PDA) device like a Pocket PC computer or a pen-based Tablet PC computer, that displays an image of an object, location or similar 2-dimensional representation of data 101. As the user changes the orientation of the mobile computer 100, the orientation of the displayed image 101 changes to provide an altered orientation of the image. One skilled in the art will recognize that the mobile computing device may represent any computing device that displays an image that is manipulated based upon the change in orientation of the device without deviating from the spirit and scope of the invention recited in the attached claims. In the disclosed embodiments, a PDA or tablet PC device is shown as it represents a display having a corresponding processing system that would support the disclosed invention. In addition, input devices such as keyboards and pointing devices such as a mouse are not needed to implement the invention. As such, a PDA or tablet PC represents a system that may be used in accordance with a system, method, and article of manufacture as recited within the attached claims. For the sake of simplicity, such a computing system is referred to as a mobile computing system herein. Of course, other computing systems may also be used and still remain consistent with the inventions recited within the attached claims.

In this embodiment of the invention, the orientation of the mobile computer 100 is provided using one or more accelerometers, or tilt-sensors, or gyroscopes that are mounted onto or within the hand-held computer 100. As the mobile computer is moved, the change in orientation may be detected by the mobile computing system orientation module. This orientation module generates a signal that may be repetitively sampled to allow the displayed image to be continuously updated. Examples of sensors that may be used in such a system include an gyroscopic ADXRS150 device from ANALOG DEVICES, of Norwood, Mass.

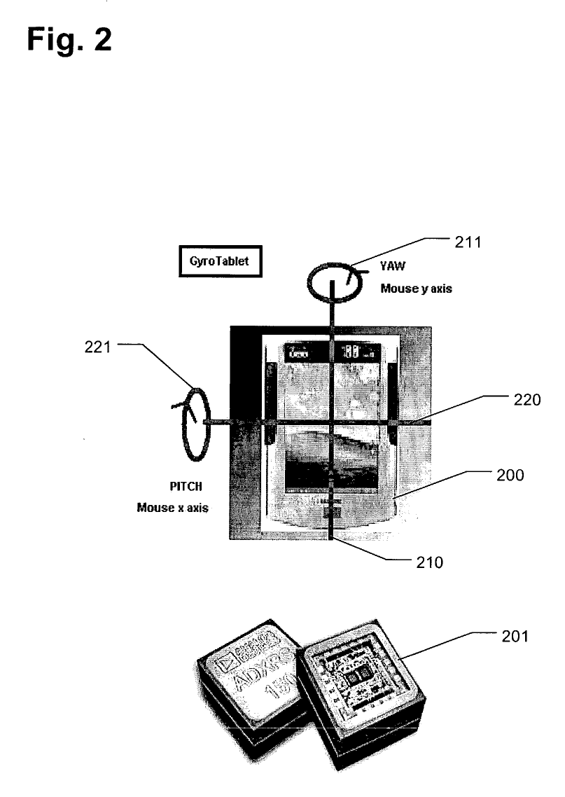

FIG. 2 illustrates geometry for an object displayed onto a screen of a mobile computing device appearing to change its orientation based upon the movement of the mobile computing device according to one possible embodiment of the present invention. In this embodiment, a mobile computer 200 is shown in which an x-axis 220 and a y-axis 210 are shown as corresponding center lines through the display of the mobile computing system 220. As the mobile computing device is moved such that the orientation of the x-axis 220 and the y-axis 210 are changed, corresponding pitch 221 and yaw 211 mouse commands are generated by the mobile computing system orientation module that is an integral part of the mobile computing system 200.

As discussed above briefly, the mobile computing system orientation module will include one or more gyroscope devices 201, such as the ADXRS150 device from ANALOG DEVICES, of Norwood, Mass. Such a device is small in size and may be mounted within the mobile computing device 200. As such, movement of the mobile computing device may be obtained from signals generated from the orientation module.

A gyroscope is a spinning wheel inside a stable frame. A spinning object resists changes to its axis of rotation. The gyroscope's frame moves freely in space. Because of the gyroscope's resistance to outside force, a gyroscope wheel will maintain its position in space relative to the gravitational force, even if you tilt the wheel. Once you spin a gyroscope wheel, its axle wants to keep pointing in the same direction. By measuring the position of the gyroscope's spinning wheel relative to its corresponding frame, a sensor can tell the pitch of an object, that is how much it is tilting away from an upright position, as well as its pitch rate, that is how quickly it is tilting. In the preferred embodiment, a solid state device is used to measure a similar effect. The ADXRS150 is a 150 degree/second angular rate sensor (gyroscope) on a single chip, complete with all of the required electronics. The sensor is built using Analog Devices' iMEMS® surface micromachining process. Two polysilicon sensing structures each contain a dither frame which is electrostatically driven to resonance. A rotation about the z axis, normal to the plane of the chip, produces a Coriolis force which displaces the sensing structures perpendicular to the vibratory motion. This Coriolis motion is detected by a series of capacitive pickoff structures on the edges of the sensing structures. The resulting signal is amplified and demodulated to produce the rate signal output.

Once an orientation module is constructed using the above principles, an application program executing within the mobile computing system may interpret signals from the orientation module to be mouse movement commands in the corresponding x-axis and y-axis directions. These mouse movement commands may then be used by the application programs to modify an image that is displayed by the mobile computing system.

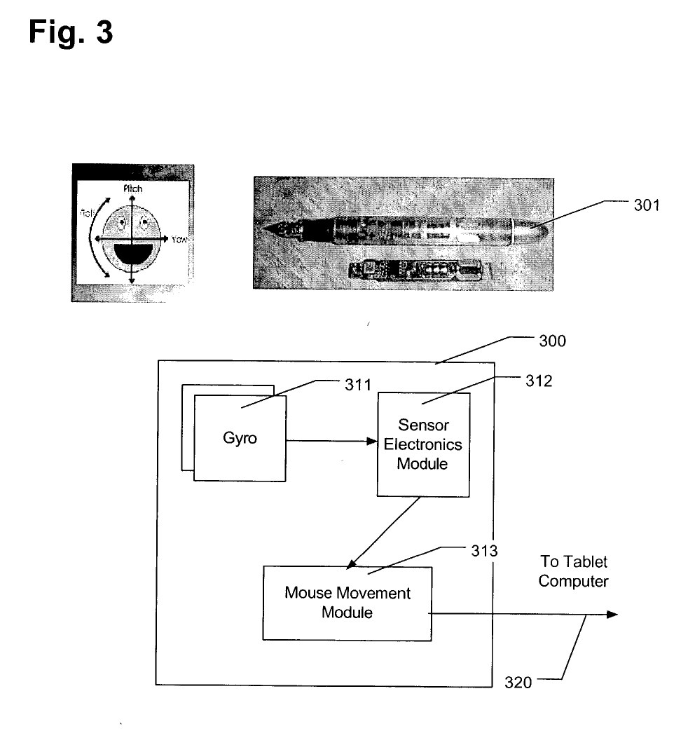

FIG. 3 illustrates a mobile computing device orientation module according to another embodiment of the present invention. The mobile computing device orientation module 300 has one or more gyroscope modules 311, a sensor electronics module 312, and a mouse movement module 313. The gyroscope modules 311, as discussed above, utilize a polysilicon sensing structures which is electrostatically oscillated. The frame is typically mounted onto a structure that is part of the mobile computing system; as such, movement of the mobile computing system results in movement of the gyroscopic structure and frame causing generation of a signal. In alternate embodiments, the mobile computing device orientation module may be incorporated in other movable devices 301 that communicate with the mobile computing system. In these alternate embodiments, the movement of the other movable devices is the motion that alters the image displayed on the mobile computing device.

The output signal from the gyroscopes 311 is electronically processed within a sensor electronics module 312. The output from the sensor electronics module 312 is passed to the mouse movement module 313 to generate mouse movement commands in an x-axis and y-axis that can be transmitted to the mobile computing system. Typically the sensor electronics module 312 will electronically process and condition the signals from the gyroscope modules 311 such that the signals can be periodically samples to generate the corresponding mouse movement commands in the mouse movement module 313. The mouse commands are sent over a serial connection, such as a Universal Serial Bus (USB) connection 320. Of course, other communications channels may be used to generate and transmit the mouse movement commands to the mobile computing system without deviating from the spirit and scope of the present invention as recited within the attached claims.

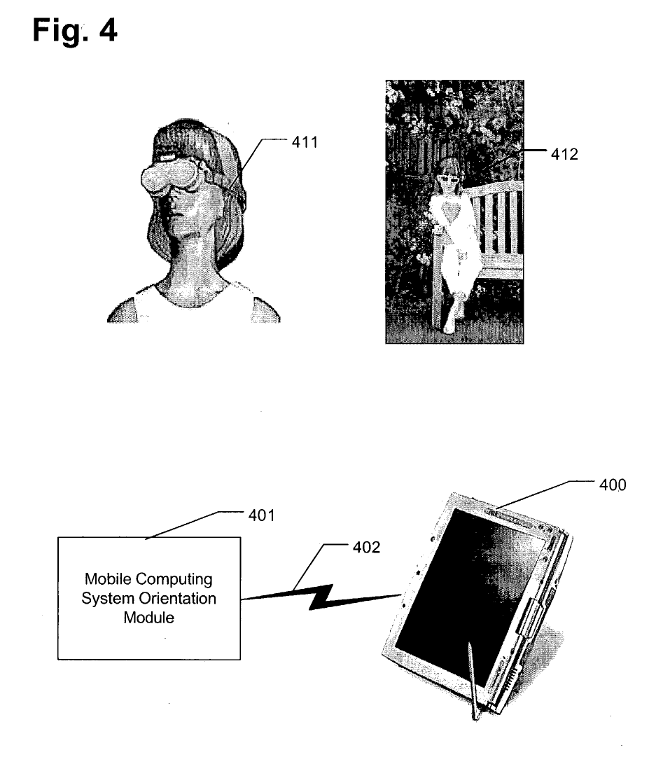

FIG. 4 illustrates use of a mobile computing device orientation module that is remote from the computing device according to an example embodiment of the present invention. As discussed above, in alternate embodiments of the present invention, the mobile computing device orientation module 401 is separate from the computing system 400 and communicate over a wireless connection 402. This wireless connection 402 may consist of IR communications and RF communications, such as the standard wireless communication channels without deviating from the spirit and scope of the present invention as recited in the attached claims. For example, a well known RF communications standard commonly identified as “Bluetooth” technology provides wireless communications between computing devices over a wireless serial communications channel could be used.

In such an embodiment, the device orientation module 401 is mounted upon an object such as goggles 411 and glasses 412 that may be readily worn by an individual. The movement of the object as an individual moved would be detected by the gyroscopes and transmitted to the mobile computing device 400. The mobile computing device 400 may then use the generated mouse movement commands to alter the displayed image.

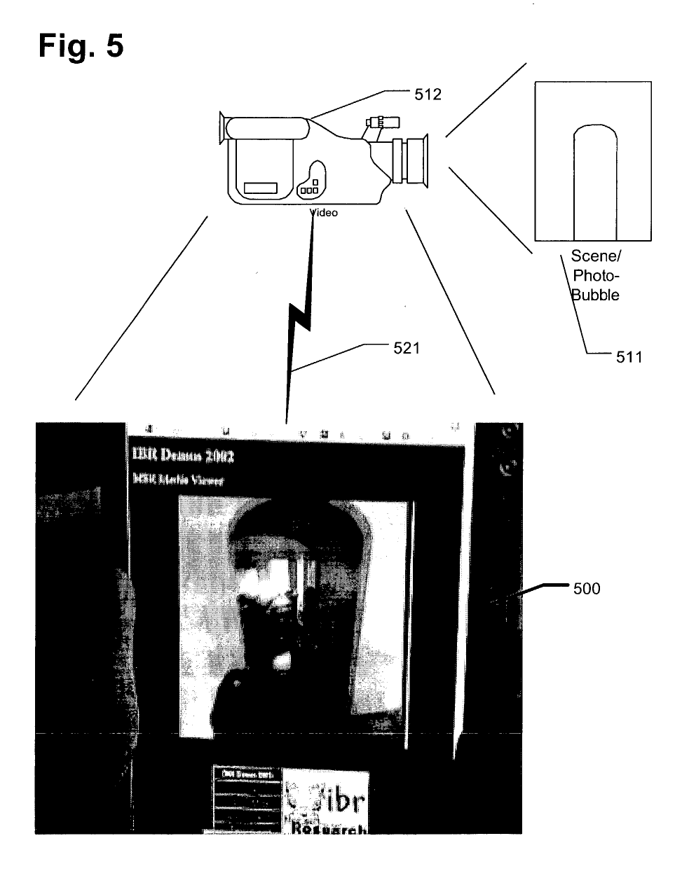

FIG. 5 illustrates use of a mobile computing device appearing to display an image of a remote location according to another example embodiment of the present invention. The mobile computing device 500 displays an image of a scene within a remote scene and/or photo-bubble 511. In this embodiment, the photo-bubble represents an electronic set of images that represent the space within a geographical location as viewed as someone moves through the space. The images presented upon the mobile computing system 500 may be images retrieved and generated from a previously stored set of images and obtained from a live video source 512 where the field of view of space that is displayed is controlled by the output from the device orientation module.

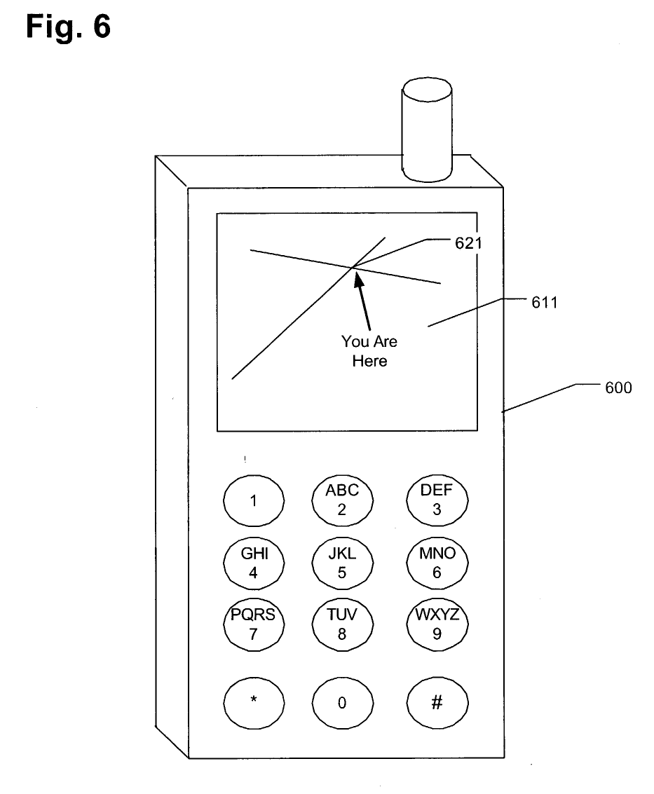

FIG. 6 illustrates use of another mobile computing device appearing to its physical location within a spatial coordinate system according to another example embodiment of the present invention. In this embodiment of the invention, the mobile computing device 600 is a cell phone having a display device 611 capable of displaying 2-dimensional map information. The output of the device orientation module provides a processing module within the mobile computing device 600 with continuous information of the movement of the mobile computing device. This information may be processed within the mobile computing system 600 to allow display of the position of the mobile computing system 600 within a displayed coordinate system illustrated by a displayed map as the mobile computing system is moved. Such an embodiment for the invention provides an ability to display position information of the mobile computing system accurately once an initial position for the processing system is provided to the processing system.

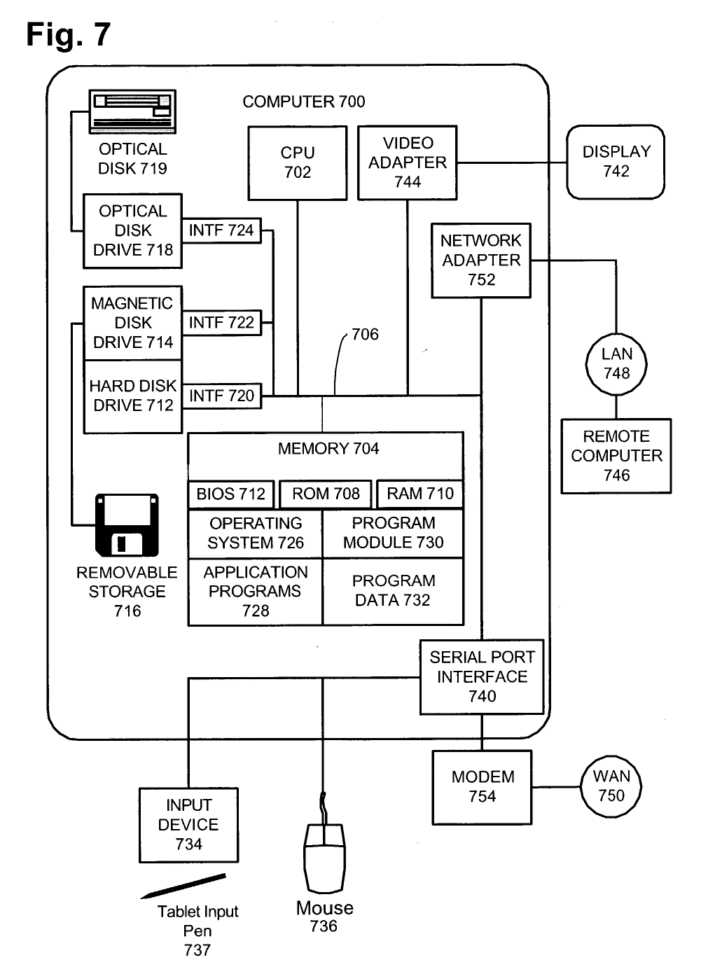

With reference to FIG. 7, an exemplary computing system for embodiments of the invention includes a general purpose computing device in the form of a conventional computer system 700, including a processor unit 702, a system memory 704, and a system bus 706 that couples various system components including the system memory 704 to the processor unit 700. The system bus 706 may be any of several types of bus structures including a memory bus or memory controller, a peripheral bus and a local bus using any of a variety of bus architectures. The system memory includes read only memory (ROM) 708 and random access memory (RAM) 710. A basic input/output system 712 (BIOS), which contains basic routines that help transfer information between elements within the computer system 700, is stored in ROM 708.

The computer system 700 further includes a hard disk drive 712 for reading from and writing to a hard disk, a magnetic disk drive 714 for reading from or writing to a removable magnetic disk 716, and an optical disk drive 718 for reading from or writing to a removable optical disk 719 such as a CD ROM, DVD, or other optical media. The hard disk drive 712, magnetic disk drive 714, and optical disk drive 718 are connected to the system bus 706 by a hard disk drive interface 720, a magnetic disk drive interface 722, and an optical drive interface 724, respectively. The drives and their associated computer-readable media provide nonvolatile storage of computer readable instructions, data structures, programs, and other data for the computer system 700.

Although the exemplary environment described herein employs a hard disk, a removable magnetic disk 716, and a removable optical disk 719, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 316, optical disk 719, ROM 708 or RAM 710, including an operating system 726, one or more application programs 728, other program modules 730, and program data 732. A user may enter commands and information into the computer system 300 through input devices such as a keyboard 734 and mouse 736 or other pointing device. Examples of other input devices may include a microphone, joystick, game pad, satellite dish, and scanner. For hand-held devices and tablet PC devices, electronic pen input devices may also be used. These and other input devices are often connected to the processing unit 702 through a serial port interface 740 that is coupled to the system bus 706. Nevertheless, these input devices also may be connected by other interfaces, such as a parallel port, game port, or a universal serial bus (USB). A monitor 742 or other type of display device is also connected to the system bus 706 via an interface, such as a video adapter 744. In addition to the monitor 742, computer systems typically include other peripheral output devices (not shown), such as speakers and printers.

The computer system 700 may operate in a networked environment using logical connections to one or more remote computers, such as a remote computer 746. The remote computer 746 may be a computer system, a server, a router, a network PC, a peer device or other common network node, and typically includes many or all of the elements described above relative to the computer system 700. The network connections include a local area network (LAN) 748 and a wide area network (WAN) 750. Such networking environments are commonplace in offices, enterprise-wide computer networks, intranets, and the Internet.

When used in a LAN networking environment, the computer system 700 is connected to the local network 748 through a network interface or adapter 752. When used in a WAN networking environment, the computer system 700 typically includes a modem 754 or other means for establishing communications over the wide area network 750, such as the Internet. The modem 754, which may be internal or external, is connected to the system bus 706 via the serial port interface 740. In a networked environment, program modules depicted relative to the computer system 700, or portions thereof, may be stored in the remote memory storage device. It will be appreciated that the network connections shown are exemplary, and other means of establishing a communication link between the computers may be used.

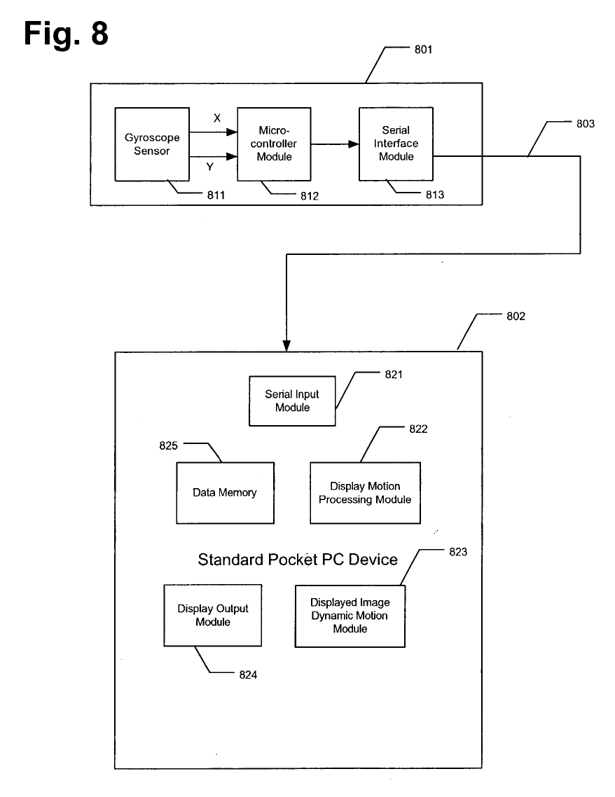

FIG. 8 illustrates a block diagram for an mobile computing and processing system according to an embodiment of the present invention. In the example embodiment shown herein, the system includes an orientation measurement module 801, a mobile computing system 802, and a serial connection between them 803.

The orientation measurement module 801 possesses a gyroscope sensor module 811, a microcontroller module 812, and a serial interface module 813. The tilt sensor module 811, which may be constructed using the gyroscope sensor as discussed above, generated an X and a Y static orientation measurement that is passed to the microcontroller module 812. The microcontroller module 812 performs all control and communications functions to obtain the orientation measurements and transmit them to the hand-held computer 802 as needed. The serial interface module 813 formats and transmits the data over the serial communications link in a desired protocol.

The mobile computing system 802 possesses a set of processing modules to implement any of the above motion and display application discussed in reference to FIGS. 4-6 above. This set of processing modules includes a serial input module 821, a display motion processing module 822, a Displayed image dynamic motion module 823, a display output module 824, and a data memory module 825. The serial input module 821 receives and decodes the data transmitted over the serial communications link in the desired protocol. The display motion processing module 822 performs the location transformation and projection calculations needed to update a displayed image of an object. The displayed image dynamic motion module 823 provides the processing needed to dynamically move an image within the field of view of the computer 802 if desired. The display output module 824 performs the display generation functions to output the 3D representation of the object onto the display of the computer 802. The data memory module 825 contains the data representations for the object and its projection onto the display screen of the computer 802 that is used by the other processing modules.

The serial connection between them 803 may be constructed as any serial connection between two digital processing devices such as an RS-232 connection, a USB connection, a Firewire connection or any other serial communication protocol. In addition, one skilled in the art will recognize that the orientation measurement module 801 may be integrated within the hand-held computer 802 where the tilt sensor 811 is a peripheral device of a processor within the hand-held computer 802 without deviating from the spirit and scope of the present invention as recited in the attached claims.

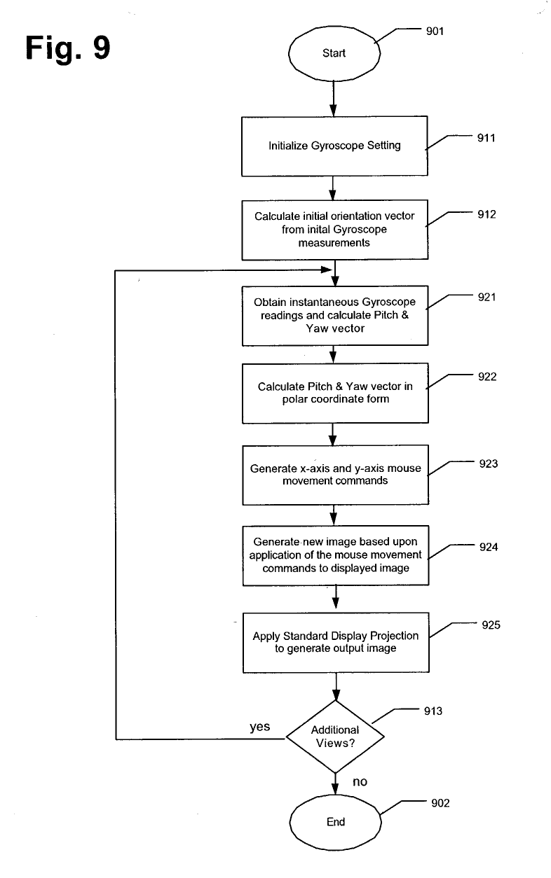

FIG. 9 illustrates an operational flow for an image manipulation and display processing system according to yet another example embodiment of the present invention. The processing begins 901 and an initial set of gyroscope readings are obtained in module 911 in order to initialize the motion processing system to an initial orientation to begin the display of an object. These initial measurements are processed within module 912 to calculate an initial position vector.

Once the initialization process is completed, the display update process begins with a set of instantaneous accelerometer readings being obtained in module 921. A current measure of a pitch and yaw vector is calculated in module 922. These vectors are used in module 923 to generate x-axis and y-axis mouse movement commands. The x-axis and y-axis mouse movement commands are used in module 924 to generate a moved output image based upon the application of the mouse movement commands to the previously generated image. This new output image is displayed to the user in module 925.

Test module 913 determines if an additional update for the output image is to be generated. If test module 913 determines that an additional output image is to be generated, the processing returns to module 921 where a new set of gyroscope readings are obtained and used in the generation of the next output image. If test module 913 determines that no additional output images are to be generated, the processing ends 902.

FIG. 7 illustrates an example of a suitable operating environment 700 in which the invention may be implemented. The operating environment is only one example of a suitable operating environment 700 and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A computing system 700 typically includes at least some form of computer readable media. Computer readable media can be any available media that can be accessed by the system 700. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computer 100.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

While the above embodiments of the present invention describe a processing system for altering an image displayed to a user, one skilled in the art will recognize that the various computing architectures may be used to implement the present invention as recited within the attached claims. It is to be understood that other embodiments may be utilized and operational changes may be made without departing from the scope of the present invention.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture for altering an image displayed to a user based upon the proximity of the user to the display device.

What is claimed is:

1. A system for altering a computer generated image of an object displayed upon a display device, the system comprising:
a display device orientation measurement module for obtaining a measure of a spatial orientation of the display device; and
a mobile processing module for generating the computer generated image of an object;
wherein the computer generated image of the object is generated using the measurements of the spatial orientation of the display device to determine a displayed orientation of the object.

2. The system according to claim 1, wherein display device orientation measurement module comprises a gyroscope sensor module for measuring the orientation of the display device in at least two dimensions.

3. The system according to claim 2, wherein display device orientation measurement module further comprises a microcontroller processing module to pre-process the orientation measurements before transmission to the mobile processing module.

4. The system according to claim 2, wherein the display device orientation measurement module transmits the orientation measurements to the mobile processing module over a serial communications link.

5. The system according to claim 4, wherein the serial communications link is wireless connection.

6. The system according to claim 4, wherein the serial communications link is USB connection.

7. The system according to claim 1, wherein the hand-held processing module comprises a display motion processing module for generating the computer generated image of an object using the orientation measurements; and
the display motion processing module generates the computer generated image of an object by projecting the image of an object onto the display device based upon the orientation of the display device as contained in the orientation measurements.

8. A method for altering a computer generated image of an object displayed upon a display device, the display device having a display device orientation measurement module for obtaining a measure of a spatial orientation of the display device, the method comprising:
obtaining a set of orientation measurements for the display device from the display device orientation measurement module;
generating a set of x-axis and y-axis mouse commands using the set of orientation measurements for use in generating the computer generated image of an object; and
applying the set of x-axis and y-axis mouse commands to a displayed image within the computer generated image.

9. The method according to claim 8, wherein the display device orientation measurement module comprises a gyroscope sensor for measuring the orientation of the display device in at least two dimensions.

10. The method according to claim 9, wherein display device orientation measurement module further comprises a microcontroller processing module to pre-process the orientation measurements before transmission to a mobile processing module; and
the mobile processing module generates and applies the mouse movement commands to generate the image of an object.

11. The method according to claim 10, wherein the display device orientation measurement module transmits the orientation measurements to the mobile processing module over a serial communications link.

12. The method according to claim 11, wherein the serial communications link used in transmitting the orientation measurements is a wireless communications channel.

13. The method according to claim 11, wherein the serial communications link used in transmitting the orientation measurements is a USB communications channel.

14. A computer program data product readable by a computing system and encoding a set of computer instructions implementing a method for altering a computer generated image of an object displayed upon a display device, the display device having a display device orientation measurement module for obtaining a measure of a spatial orientation of the display device, the method comprising:
obtaining a set of orientation measurements for the display device from the display device orientation measurement module;
generating a set of x-axis and y-axis mouse commands using the set of orientation measurements for use in generating the computer generated image of an object; and
applying the set of x-axis and y-axis mouse commands to a displayed image within the computer generated image.

15. The computer program data product according to claim 14, wherein the display device orientation measurement module comprises a gyroscope sensor for measuring the orientation of the display device in at least two dimensions.

16. The computer program data product according to claim 15, wherein display device orientation measurement module further comprises a microcontroller processing module to pre-process the orientation measurements before transmission to a mobile processing module; and
the mobile processing module generates and applies the mouse movement commands to generate the image of an object.

17. The computer program data product according to claim 16, wherein the display device orientation measurement module transmits the orientation measurements to the mobile processing module over a serial communications link.

18. The computer program data product according to claim 17, wherein the serial communications link used in transmitting the orientation measurements is a wireless communications channel.

19. The computer program data product according to claim 17, wherein the serial communications link used in transmitting the orientation measurements is a USB communications channel.
